(19) United States
(12) Patent Application Publication
(10) Pub. No.: US 2004/0232089 A1
(43) Pub. Date: Nov. 25, 2004

(54) Biocidal compounds for treating water

(75) Inventors: Paolo Manzotti, Monza (IT); Francesco Monteleone, S. Agata Di Cassina De' Pecchi (IT)

Correspondence Address: MODIANO & ASSOCIATI, Via Meravigli, 16, MILANO, 20123, IT

(73) Assignee: VANETTA S.p.A.

(21) Appl. No.: 10/740,396

(22) Filed: Dec. 22, 2003

(30) Foreign Application Priority Data
May 20, 2003 (IT) MI2003A001011

(51) Int. Cl. C02F 1/50

(52) U.S. Cl. 210/764

(57) ABSTRACT

The present invention relates to a method for the treatment of water pools, preferably fresh or salt water in basins of any size, waters in conduits for civil and industrial use, and ballast waters in the maritime practice. Aim of the invention is to remove biological contamination by plant and animal organisms. Particularly, this method exploits thebiocidal properties of some of the menadione derivatives.

The present method is particularly useful for eliminating both macro- and micro aquatic infesting freshwater and marine organisms, particularly non-indigenous species, such as plants and algae, phytoplankton and zooplankton organisms, particularly adults, larval stages, resting stages andpropagules and gram positive and negative bacteria.

### BACKGROUND OF THE INVENTION

The present invention relates to the use of some menadione derivatives as biocides for either fresh or salt water in general, and particularly, but non exclusively, for treating ballast waters.

Common practice in the merchant navy is to load water (either fresh or salt water) as ballast in the bilge of the ship in order to control its steerability, stability and the waterline. When a ship is empty of cargo, it fills with ballast water. When it loads cargo, the ballast water is discharged. Said water can be loaded or unloaded at various locations of the trip of the ship, besides of course the harbours of departure and destination.

Container ships and oil tankers can visit up to 10-15 harbours during a full voyage and load or unload ballast water up to 15 times. It is estimated that ballast water transferred every year is approximately 10-15000 millions of tons and any plankton organism, both in the larval and adult stage, in the vicinity of the withdrawal site may be collected and unloaded in subsequent destination harbours.

Accordingly, hundreds of autotrophic and heterotrophic organisms can be transferred within a few years from one area to another and from one continent to another, thus resulting in a rapid biological invasion with major consequences for the host ecosystem

In view of the huge volume of trades involving the United States, they are particularly sensitive to this problem. After 1990, American biologists signalled the settlement and abnormal growth in US coastal regions of Zebra Mussel (hereinafter Dreissena polymorpha), a non-indigenous bivalve that is native to the drainage basins of the Black, Caspian and Aral Seas in Eastern Europe and Western Asia and reached America almost certainly through ballast water of cargo boats. Large colonies of this bivalve then rapidly settled up to the area of the Great Lakes (in this regard, see GLERL, “The ecological approach to the Zebra mussel Infestation in the Great Lakes” February 1994).

Colonies of this bivalve can cause fouling problems of both cooling water ducts of electrical plants or other industrial sites and conduits for drinking water. Furthermore, said colonies can interfere with the distribution of phytoplankton and promote the growth of some Cyanobacteria (blue-green algae), (such as for example microcystins, group of toxins produced and released by them), which are toxic to both fish and humans (as detailed in NOAA 1996).

The Sargassum muticum algae originally from the Centre-South America and introduced in the US West coast in the forties, now infests the East coast and competes with the native species thus modifying the original ecosystem (Giver, “Effects of the invasive seaweed Sargassum muticum on native marine communities in Northern Puget Sound”, Washington Jan 24-27, 1999).

A particularly evident case relates to the Bay of San Francisco where it is estimated that about 230 introduced new exotic species (mollusc, crustaceans, algae, dinoflagellates) in the last decades and that the introduction rate is of 4 new species per year (Cohen, “Prevention vs control of biological invasion”, Washington Jan. 24-27, 1999).

Till a few years ago, the most widespread method for controlling the microfauna and microflora of ballast waters was to cyclically exchange fresh water with salt water in order to fight organisms intolerant to the salinity of sea water (and the vice versa). Said method however proved to be incapable of effectively solving the problem also because of the difficulty in certain circumstances to find the required amount of fresh water.

The severity of this situation has been fully understood recently when international agreements started to be discussed in order to try to control the abnormal diffusion of micro-organisms through making some treatment of ballast waters mandatory, which agreement are still in course of negotiations.

In this regard, in 1990 the Congress of the United States passed a law (“The non Indigenous Aquatic Prevention and Control Act” Title I of P.L. 101-646 (104 Stat. 4761, 16 U.S.C. 4701, enacted Nov. 29, 1990)) which among others, has promoted studies for controlling and preventing the development of non-indigenous species in internal waters of the US.

The proposed methods ranged from UV irradiation to filtration, ultrasound treatment and ozonisation of said water.

On the contrary, with regard to the possible use of organic molecules as biocides, some patents (such as JP 03-131669) have started disclosing rather generically effectiveness and activity of disinfectant compositions comprising aromatic substances such as variably substituted phenols and naphthols, as well as substituted ubiquinones, naphthoquinones and anthraquinones.

More recently US patent U.S. Pat. No. 6,164,244 has taught the use of a natural derivative of naphthoquinone, commonly termed juglone (5-hydroxy-1,4-naphthalenedione), which is normally present in a low concentration in shell of walnuts (Juglans regia) for the specific treatment of ballast water. According to the above patent, the juglone would show an effective biocidal activity in controlling many organisms which may be present in ballast waters. However, the use of juglone is subjected to the necessity of coping with the problem of its extremely low solubility in water. Furthermore, it is known (see U.S. Pat. No. 3,602,194) that the juglone can be used to eliminate fish populations not desired in internal water, which is however a disadvantage when ballast waters treated with this compound has to be discharged into the sea.

In U.S. Pat. No. 6,340,468, the properties of juglone were then extended to other quinones such benzoquinones, naphtoquinones and anthraquinones and derivatives thereof. This document shows the existence of a close relationship between activity and the presence of a hydroxyl group as well as an obvious though inexplicable variability of effectiveness on most dangerous organisms. Furthermore there is still the problem of water solubility of the active principle.

To solve this problem one resorts to using suitable organic solvents (such as alcohols and ketons) in which quinone is soluble in order to promote the dispersion thereof in the water to be treated, thus allowing a better control of concentration homogeneity. Such a solution is disclosed by U.S. Pat. No. 6,164,244 in the specific case of juglone.

However, even the solvents used often have a marked toxicity for almost all living organisms and in addition to that, the expedient suggested is a palliative since the solvent is diluted and the quinone precipitates out again as a solid as soon as the solution gets into contact with water.

Still with a view to a complete evaluation of toxicity, the breaking down of juglone to innocuous by-products is strictly dependent on the photo-exposition thereof and also it does not always proceed sufficiently rapidly.

Therefore, the need was felt of finding an effective and low cost way for controlling contamination of water pools of various origin and particularly the transfer of non-indigenous animal and vegetable species by ballast waters.

In view of all the above, an aim of the present invention is to provide a treatment method for controlling, inhibiting the growth and eliminating animal and vegetable aquatic species which overcomes the problems encountered with the treatments currently in use.

Within this aim, a main object is to provide a method for treatment preferably of either fresh or salt water in basins of any size, waters in conduits for civil and industrial use, and ballast waters, for controlling, eliminating and inhibiting the growth of non-indigenous species, said method using compounds which are highly active against a huge number of said autotrophic and heterotrophic aquatic species.

Another object is to provide a method for treatment preferably of either fresh or salt water in basins of any size, waters in conduits for civil and industrial use, and ballast waters, said method using compounds which are not harmful for the environment in which they are released after the cycle of use thereof.

Another object is to provide a method for treatment preferably of either fresh or salt water in water basins of any size, waters in conduits for civil and industrial use, and ballast water, said method using highly water soluble compounds in order to allow the desired concentration be obtained through the use of the least amount as possible of said compounds.

Still another object is that of providing a treatment method for controlling, inhibiting growth and decontaminating autotrophic and heterotrophic aquatic species, which method can be applied effectively to water pools of small and medium volume, such as aquariums of any shape and size.

Still another object is to provide compounds suitable to be used in the above method and which are quickly and fully biodegradable once they have completed their useful cycle.

Another object is that of providing compounds to be used in the above method, which are promptly available at a low cost.

### SUMMARY OF THE INVENTION

These and other aims and objects are achieved by a method for preventing growth or eliminating the presence of at least one aquatic infesting plants, animals and microorganisms, wherein said method comprises the step of adding to the water which is at risk of being contaminated or already infested by said aquatic infesting organism at least one compound selected from the group consisting of: menadione nicotinamide bisulphite (MNB), menadione dimethylpyrimidinole bisulphite (MPB), menadione nicotinic acid bisulphite, menadione adenine bisulphite, menadione triptophane bisulphite, menadione histidine bisulphite, menadione para-aminobenzoic acid bisulphite, and wherein said at least one aquatic infesting organism is selected from the group consisting of phytoplankton and zooplankton organisms, gram positive and gram negative bacteria and resting stages of these organisms.

### DETAILED DESCRIPTION OF THE INVENTION

Advantageously the compound used is menadione nicotinamide bisulphite (MNB).

The phytoplankton organisms treated are preferably green-algae and zooplankton organisms are selected from the group consisting of copepods (vectors of Vibrio cholerae), other holoplanktonic and meroplanktonic organisms, and some resting stages.

Microbes treated are both gram-positive and gram-negative bacteria. Preferably, said bacteria belong to the families of Enterobacteriaceae, Pseudomonaceae, Alteromonadaceae, Vibrionaceae, Micrococcaceae and Bacillaceae. More preferably, the treated bacteria belong to genera Escherichia, Salmonella, Pseudomonas, Alteromonas, Bacillus, Corynebacterium, Vibrio, Aeromonas, Micrococcus, Staphylococcus and Clostridium. Species preferably treated are Escherichia coli, Salmonella sp., Pseudomonas sp., Alteromonas sp., Shigella sonnei, Staphylococcus aureus, Vibrio parahaemolyticus, Bacillus subtilis and Proteus sp.

Preferably the aquatic infesting organisms are selected from the group comprising Dreissena polymorpha, Isochrisis galbana, Eurytemora affinis, Tigriopus fulvus, Artemia salina.

According to a particular aspect of the present invention, it is possible to obtain an effective concentration of the compounds selected from the group consisting of: menadione nicotinamide bisulphite (MNB), menadione dimethylpyrimidinole bisulphite (MPB), menadione nicotinic acid bisulphite, menadione adenine bisulphite, menadione triptophane bisulphite, menadione histidine bisulphite, menadione para-aminobenzoic acid bisulphite, and mixtures thereof, to prevent the growth or eliminating the presence of all involved organisms. In particular, said effective concentration can generally range from 0.5 ppm to 500 ppm, preferably from 0.5 ppm to 200 ppm, most preferably from 1 ppm to 100 ppm.

In view of the surprising efficacy of the compounds used, the method according to the present invention proved surprisingly suitable for treating water in general, and particularly fresh and salt water in basins of any size, water in conduits for civil and industrial use, and ballast water in ship, in which latter field as seen above the effective solutions for controlling infesting organisms were poor.

Preferably, the method according to the invention can be applied to ballast water as used in the maritime practice.

Still preferably, the methods as taught herein can be effectively applied to aquaria of any shape and size as well as either artificial or natural water basins of either fresh and salt water, in which it is desirable to completely eliminate given aquatic vegetable or animal species.

Still preferably, the methods as taught herein can be effectively applied to treat water in conduits for civil and industrial use.

All the molecules used in the method of the invention are known. The cationic portion of these compounds consists of a generic aromatic nitrogenous base, salificated with a functionalised naphthoquinone nucleus, which is currently used as a commercial source of Vitamin K3 in feeding animals for husbandry, including fishes.

By way of a non limitative example, herein below is showed the structure of menadione nicotinamide bisulphite (MNB):

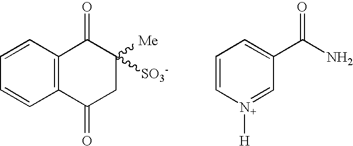

All the aforementioned compounds derived from menadione do not have any hydroxyl group bound to the naphthoquinone ring. This aspect is of particular interest since the great majority of the molecules used for water biocidal treatment, and particularly the most active molecules with respect to Dreissena polymorpha (which is one of the more feared invasive organism), have an hydroxy substituent bound to the aromatic ring.

In some cases, said structural aspect was explicitly deemed essential to the purpose of the activity of the molecule (see U.S. Pat. No. 6,164,244 and U.S. Pat. No. 6,340,468).

Surprisingly, it has been now found that even the absence of hydroxyl substituents is fully compatible with a remarkable biocidal activity against various organisms, including Dreissena polymorpha.

Moreover, it was surprisingly found that the absence of an hydroxyl substituent results in an interesting modulation of the biocidal activity, particularly reducing the toxicity of the active ingredients on ichthyic fauna, thus limiting the negative impact of unloading into the sea both treated ballast water and water from civil and industrial conduits. In this regard, it should be remembered that for example MNB and MPB are currently administered as vitamin K precursors in feedstuff for animals for husbandry, including fish.

Another particularly advantageous aspect relates to the water solubility of MNB, MPB, menadione nicotinic acid bisulphite, menadione adenine bisulphite, menadione triptophane bisulphite, menadione histidine bisulphite, menadione para-aminobenzoic acid bisulphite.

Indeed, one of the most evident advantages using the above compounds according to the invention is its high hydrosolubility so to obtain an even concentration of the active ingredient in the treated water is very easy. This is particularly important since said molecules are commonly used as disinfestants in extremely small quantities (of the order of a few parts per million) and in any event in the least amounts as possible.

On the contrary, with those biocides which dissolve poorly in the water pool, the inhibition of the target organisms only takes place in a restricted area surrounding the biocide particle whereas a substantial survival of said organisms is to be expected in the great part of the bulk of treated water. This is extremely important whenever water of water basins of any size, water from civil and industrial conduits and ballast water should be treated because of the huge quantity of liquid to be effectively disinfested.

With regard to this, it has been also found that increasing the solubility of the compound through its salification with an organic base rather than with a simple metal such as sodium (such as for example in menadione sodium bisulphite or MSB) has also allowed to overcome the problems relative to the possible alteration of the osmotic balance following the disposal of the waters at the end of their cycle of use.

In fact, in case of treatment of fresh water basins or water conduits opening into fresh water basins, releasing into the environment abnormal quantities of sodium ion is highly dangerous for the receiving ecosystem since the modification of saline concentrations is not compatible with the survival of the plant and animal species in the vicinity of the site of release.

Furthermore, in case of active ingredients known to have a toxic activity on the ichthyic fauna, a change in their concentration as a result of poor water solubility of the active ingredient badly affects the entire ecosystem and not only the target organisms to be eliminated.

A further advantage of the molecules used according to the invention resides in the improved biodegradability thereof, which is independent on their photo-exposure, such condition, on the contrary, U.S. Pat. No. 6,164,244 considered critical for the prompt degradation of the molecules disclosed therein, in order to limit their ascertained toxicity toward all organisms present.

Normally, the degradability of a substance is a factor impossible to predict based on the structure thereof. In the case of the compounds used in the present invention, and particularly MNB and MPB, the present inventors have found a surprisingly positive result.

In fact, based on data available with respect to the most similar compounds to the menadione derivatives disclosed herein, one would expect a degradability in the range of 0% (percentage calculated based on the initial mass expressed in mg/l) typical of menadione (2-methyl-1,4-naphthalenedione) and 17% (assessed after 28 days) typical of menadione sodium bisulphite (which calculation was performed in accordance with the guidelines OECD301 A attached to directive EEC 92/69/EEC C4-A).

On the contrary, it was unexpectedly found that 7 days after the beginning of the test the degradability of MNB and MPB was actually eight time greater than that of MSB, whereas after 28 days it was 40%, and thus well above the 17% reported for MSB.

It is noted therefore that with the biocidal activity and hydrosolubility of the compounds of the invention and MSB being substantially the same, the compounds of the invention show an unexpectedly higher degree of biodegradability than the related compounds, thus resulting to be more suitable for the aim of the invention.

Furthermore, this result is hardly explainable even after proving it experimentally, since the only real difference between the known compounds on the one hand and MNB and MPB on the other hand is based on the cationic portion. However, the variation of the cationic part using an aromatic nitrogen base rather than for example a metallic counter-ion proved to have a significant influence on biodegradability of the molecules as a whole.

In addition, all the above mentioned menadione derivatives are easily available since the use of their naphthoquinonic nucleus in the industrial process for synthesising vitamin K analogues allows a quick and low cost synthesis thereof.

On the contrary, especially with regard to hydroxilated molecules, besides the already mentioned drawbacks (such as for example their known toxicity on fish), the fact they are not easily available and their high cost have to be coped with. Juglone, for example, does not exist on the market in industrial process amounts but it is rather synthesised in small amounts for special applications and its extraction thereof from walnuts shells (see U.S. Pat. No. 6,164,244), though potentially interesting, is no doubt complicated and expensive.

Further advantages and characteristics of the invention will become apparent from a description of the following preferred but not limiting examples.

### EXAMPLE 1

The following data show the methods and the results of the efficacy experiments carried out on some phyto- and zooplankton species which are considered as possible targets of the method claimed herein and the toxicity on ichthyic fauna.

Inhibition of Planktonic Microalgae Duplication

This test was carried out by using the microalga Chlorella sp., it is a small (2-10 microns diameter) green single celled microalga with a spherical cell shape. This genus is capable of both autotrophic and heterotrophic growth which may contribute to its ability to rapidly overtake other algae in culture. In laboratory, Chlorella coltures are started by taking from the branchs, inoculates basis, about 10 ml of monospecific colture, and adding 700 ml of 0,22 mm filtered sea-water, enriched with Walne colture medium and vitamins.

Flasks with algae are kept in a thermostatic room, at 20° C.±0,5; lighting is supplied by 30 watt fluorescent neon tubes and by a 18 watt Osram-fluora lamp, with a photoperiod 16:8 light:dark. Oxygenation is warranted by a continuous air flux in the flask, this is also a way to avoid cells sedimentation. Test was carried out in the thermostatic room, at 20° C., with a 16:8 light:dark cycle in glass test-tube. The tested product has been dissolved in the culture medium, at a double concentration respect to the final wanted. In this way, the final volume (25 ml) was obtained by adding to the 12,5 ml of algal solution (2×10⁶ cell/ml) present in the sterile test-tube, known volumes of toxic solution and culture medium, in order to obtain the desired final concentration of MNB: 0.1-0.5-1-5-10-20 mg/L. Each treatment, and the control, were performed in three replicates. Test-tubes were aerated, and kept in thermostatic room for 96 hours; after this period of time an aliquot of each replicate for each concentration was taken, and cellular densities were counted using an haemocytometer.

Results

Values of LC1 and LC50±confidence limits at 95% (IC) after 96 hours of treatment:

LC1: 0.002 mg/L (0.000-0.009)

LC50: 0.055 mg/L (0.019-0.092)

Artemia Efficacy Test

This efficacy test was carried out by using nauplii of Artemia salina (Crustacea: Anacostraca). This organism can be found in commerce as cysts, a metabolic non-active form closed by an involucre inaccessible to every substance, excluding water and gas.

Cysts reactivation has been carried out 24 hours before the execution of tests. About 500 mg of cysts have been introduced in a 700 ml beaker, adding 500 ml of sea water, not treated and previously filtered on a millipore 0,45 μm membrane. Beakers, hermetically closed and aerated with pre-filtered air (0,22 μm), were incubated for 24 hours at 25° C., without photoperiod. For the tests E3 developing stage nauplii were employed (24 hours after cysts reactivation). Nauplii were divided from not-opened cysts by exploiting their positive fototactism: a light beam is placed near the beaker, obtaining a considerable concentration of organisms, that can be taken by using a Pasteur pipette. The following MNB concentrations have been tested: 0-0.05-0.1-0.5-1-5-10 ppm (mg/L). These solutions have been prepared immediately before carrying out the tests using natural filtered (0.22 μm) sea water (NFSW). For tests, multiwell plates (25 wells) have been used, each well has a capacity of 4 ml. In the first column there was the control solution (water without product), and in the following the different concentrations in increasing order. In each well about 20-25 individuals were added, each concentration was repeated in four replicates. Multiwell plates, hermetically closed with parafilm and lid, were incubated at dark for 24-48 hours at 25° C. After this period of time they were observed at binocular, in order to count the number of dead organisms respect to the total number of individuals. Larvae were considered dead when there was completely no movement for 10 seconds.

Mortality percentage was calculated as the mean of the four replicates for each concentration. Data were analysed by using the Probits method, in order to calculate the lethal concentration for the 50% of the population (LC50).

Results

Values of LC1 and LC50+confidence limits at 95% (IC) after:

24 hours: LC1: 3.170 mg/L (1.364-4.374)

LC50: 7.625 mg/L (6.299-8.996)

48 hours: LC1: 0.548 mg/L (0.095-1.033)

LC50: 1.840 mg/L (0.943-2.873)

Barnacle Efficacy Test

This efficacy tests was carried out by using Balanus amphitrite nauplii (Crustacea: Cirripedia). Specimens of this organism are collected in nature, and then maintained and reared in our laboratories, following a standard methodology. Adult organisms regularly produce larvae at the second naupliar stage, characterized by the typical triangular carapace, with a shield shape. The following MNB concentrations have been tested: 0-0.01-0.05-0.1-0.5-1-5-10 ppm (mg/L). These solutions have been prepared immediately before carrying out the tests using natural filtered (0.22 μm) sea water (NFSW). Stage II nauplii have been used; immediately after their emission from adults larvae were divided and put in a beaker with 0,22 mm filtered natural sea-water. For tests, multiwell plates (25 wells) have been used, each well has a capacity of 4 ml. In the first column there was the control solution (water without product), and in the following the different concentrations in increasing order. In each well about 20-25 individuals were added, each concentration was repeated in four replicates. Multiwell plates, hermetically closed with parafilm and lid, were incubated at dark for 24-48 hours at 25° C. After this period of time they were observed under a binocular microscope, in order to count the number of dead organisms respect to the total number of individuals. Larvae were considered dead when there was completely no movement for 10 seconds. Mortality percentage was calculated as the mean of the four replicates for each concentration. Data were analysed by using the Probits method, in order to calculate the lethal concentration for the 50% of the population (LC50).

Results

Values of LC50±confidence limits at 95% (IC) after:

24 hours: 0.228 mg/L (0.225-0.231)

48 hours: 0.222 mg/L (0.218-0.228)

Mussels Efficacy Test

Mussels are bivalve shellfish that grow quickly and profusely. They have two identical, convex shells. These shells are elongate, triangular and joined by a rubbery hinge ligament on the upper side. There are three main periods in the Mytilus galloprovincialis life cycle: the larval, juvenile, and adult stages. The larvae are planktonic (float in water column) during their initial three life stages: trochophore, veliger, and pediveliger.

Efficacy tests were carried out by using two larval stages of this organism: trocophora and veliger. Adult specimens of this organism were collected and transferred into our laboratories, where they were cleaned from debris, and put in single 200 ml beakers, with 0,22 mm filtered natural sea-water. Through a thermal shock, sexual products (eggs and sperma) were obtained. Fertilized eggs (about 300.000) were filtered and put in 1000 ml beakers, with 0,22 mm filtered natural sea-water. Cultures were maintained at 20° C., with a photoperiod of 16:8 light:dark. After the first 24 hours post-fertilization, trocophora stage is present. Larvae were reared and fed with a planktonic alga, Pavlova lutheri, every day they were filtered, and water was changed. Veliger stage is reached about 48-72 hours after fertilization.

The following MNB concentrations have been tested: 0-0.01-0.05-0.1-0.5-1-5-10 ppm (mg/L). These solutions have been prepared immediately before carrying out the tests using natural filtered (0.22 μm) sea water (NFSW).

For tests, multiwell plates (25 wells) have been used, each well has a capacity of 4 ml. In the first column there was the control solution (water without product), and in the following the different concentrations in increasing order. In each well about 20-25 individuals were added, each concentration was repeated in four replicates. Multiwell plates, hermetically closed with parafilm and lid, were incubated at dark for 24-48 hours at 25° C. After this period of time they were observed at binocular, in order to count the number of dead organisms respect to the total number of individuals. Larvae were considered dead when there was completely no movement for 10 seconds. Mortality percentage was calculated as the mean of the four replicates for each concentration. Data were analysed by using the Probits method, in order to calculate the lethal concentration for the 50% of the population (LC50).

Results

Values of LC50±confidence limits at 95% (IC) after 24 hours:

trocophorae: 0.108 mg/L (0.036-0.300)

veliger: 0.167 mg/L (0.067-0.418)

Copepods Efficacy Test

Copepods are small (only a few species over 1 mm) and extremely abundant, often dominating the plankton community. They form a link in the food web between the primary-producing phytoplankton and the plankton-feeding fish. The choice to test the efficacy of MNB on this kind of organism do not depend on its critical position in the food web but because these organisms are a vector for the transport of microorganism that could also be pathogens ones.

For that, efficacy test was carried out by using Tigriopus fulvus, it is a shallow-water marine species (Crustacea, Copepoda, Harpactico.da) characterized by three life stages, all variously deep-orange coloured: five nauplius substages and five copepodid substages. Nauplii have a subcircular shape, are characterized by a single red eye, and develop within 6 to 7 days. Copepods are recognisable because of their abdominal segment formation, although the last substage is difficult to distinguish from the adult female at the end of the 7-day development period. Adult sizes range from 0.8 to 1.0 mm for males and from 1.0 to 1.2 mm for females. Sexual dimorphism is detectable only by the pincer shape of antenna 1, whereas ovigerous females can quickly be recognized because of their large egg sacs. T. fulvus is a vector for the transport of Vibrio spp; it is well documented that the persistence of V. cholerae in the aquatic environment is facilitated by its ability to colonize various substrates, including zooplankton surfaces (i.e., copepods).

Copepods, sampled in their natural habitat, have been moved through suitable containers to the laboratory, where they were subjected to a specific treatment. They were first filtered through a 200 mm mesh, then washed with sterile sea-water and transferred to small 3 litres aquaria, with natural filtered (0.22 μm) sea water, T=20+0,5° C. Copepods were fed with microalgae (Chlorella spp, Tetraselmis suecica) and commercial yeast (Saccharomices spp). After the acclimatization period (one month), about 500 females were chosen and separated. The naupliar stage was then used for the efficacy test. The following MNB concentrations, have been tested: 0-0.001-0.005-0.01-0.05-0.1-0.5-1-5-10 ppm (mg/L). These solutions have been prepared immediately before carrying out the tests using natural filtered (0.22 μm) sea water (NFSW). Nauplii were used 24 hours after their hatching, multiwell plates (25 wells) were used for these tests, about 15 individuals for each well. Each concentration was performed in six replicates, plates were kept at dark, at 20° C. After 24, 48 and 72 hours they were observed at binocular, in order to count the number of dead organisms respect to the total number of individuals. Larvae were considered dead when there was completely no movement for 10 seconds. Mortality percentage was calculated as the mean of the four replicates for each concentration. Data were analysed by using the Probits method, in order to calculate the lethal concentration for the 50% of the population (LC50).

Results

Values of LC50+confidence limits at 95% (IC) after:

24 hours: 0.156 mg/L (0.127-0.193)

48 hours: 0.071 mg/L (0.057-0.088)

72 hours: 0.039 mg/L (0.031-0.049)

Inhibition of Dynoflagellates Cysts Hatching

For this test, cysts (resting stage) of Scrippsiella trochoidea (Dinophyta) were used. Scrippsiella trochoidea (order Peridiniales, subfamily Calciodinelloideae) i.e. a non-toxic autotrophic orthoperidinioid dinoflagellate producing calcareous resting cysts which are abundant in coastal marine sediments. The maturation period for S. trochoidea cysts rang between 2 and 5 weeks.

S. trochoidea cysts are very convenient for experimental purposes because their sorting and culturing is comparatively easy, the cysts being relatively abundant in sediments.

Sediments were sampled in Mar Piccolo (Taranto). The utilized method allowed us to pick up the superficial sediment layer of a certain area entirely, where most of the cysts is present. The sample was immediately kept at dark at 4° C. Sediments collected about one year ago were utilized, in order to be sure that the hatching refractoriness period of cysts was finished. The sample (about 2 ml of sediment) was then dissolved in 0,45 μm filtered natural sea-water, sonified for 1 minute (Branson Sonifier) in order to brake sediment clots, resuspended in filtered sea-water and filtered on a Endecotts sieve, with a 20 μm steel mesh. The sample was then observed with an inverted microscope cysts were collected one by one through micropipettes, and incubated in single microwells (1,5 ml) in the following experimental conditions: temperature 24° C., photoperiod 12:12 light:dark, light intensity 100 microeinstein/m², humidity 70%. Cysts were incubated in 0,45 μm filtered natural sea-water as control and in a solution with different concentration of MNB for 6 days.

Results

Values of LC50+confidence limits at 95% (IC) after 6 days:

2,65 mg/L (1,80-3,20)

Particularly, LC₅₀ of MNB were compared (Table 1) with those of other compounds which can be used for the same purpose. For example, some hydroxilated molecules were taken into consideration such as 2-methyl-5-hydroxy-1,4-naphthalenedione and juglone, as well as other some of molecules cited in the above referenced documents, such as 2-methyl-1,4-naphthalenedione and 2-methyl-anthraquinone.

TABLE 1
Toxicity experiments

| | | Mytilus | | | | |
|---|---|---|---|---|---|---|
| Target | | galloprovincialis: | | | Balanus | |
| organism/ | | trochophorae/ | | Artemia salina: | amphitrite: | |
| End-point | Chlorella sp. | veliger | Tigriopus fulvus | nauplii | nauplii | Rainbow trout |
| (ppm) | (IC₅₀ - 96 h) | (LC₅₀ - 24 h) | (LC₅₀ - 24 h) | (LC₅₀ - 48 h) | (LC₅₀ - 24 h) | (LC₅₀ - 96 h) |
| MNB | 0.05 | 0.11/0.17 | 0.16 | 1.84 | 0.23 | 0.4 |

Toxicity experiments with other compounds on similar organisms

| Target | | | | | |
|---|---|---|---|---|---|
| organism/ | | Dreissena | | | |
| End-points | Isochris galbana | polimorpha | Eurytemora | Artemia salina | Rainbow trout |
| (ppm) | (IC₅₀) | (LC₅₀) | affinis (LC₅₀) | (LC₅₀) | (LC₅₀) |
| 2-methyil-1,4- | 0.05 | 500 | 5 | 5 | 0.1 |
| naftalendione | | | | | |
| 2-methyl-5- | 0.5 | 0.2 | 5 | 5 | N.D. |
| hydroxy-1,4- | | | | | |
| naphtalenedione | | | | | |
| 2-methyl- | 0.5 | 200 | 5 | 5 | N.D. |
| antraquinone | | | | | |
| Juglone | / | 0.36-2.8 | / | / | 0.02 |
| | | | | | (assessed on |
| | | | | | Fathead |
| | | | | | Minnow) |

The extreme variability of efficacy on Dreissena polymorpha and Mytilus galloprovincialis should be noted. Particularly, the impact of the presence of the hydroxyl group is apparent from the values reported for 2-methyl-5-hydroxy-1,4-naphthalenedione (LC₅₀ is equivalent to 0,2 ppm, that is very close to that of Juglone) and 2-methyl-1,4-naphtalenedione (LC₅₀ is equivalent to 500 ppm, a value 2500 time higher). Such tendency is also confirmed by 2-methyl-anthraquinone (LC₅₀=200 ppm).

Although it is not desired to be bound by any theory, it seems possible that among the possible explanations for such a behaviour there is also an insufficient distribution and homogeneity of the active ingredient, particularly in view of the water insolubility of 2-methyl quinones.

Sole exceptions of this general tendency is MNB which shows a biocidal activity with respect to mollusc Dreissena polymorpha and Mytilus galloprovincialis which is compatible with large scale use.

Positive results were also obtained by MNB also with respect to phytoplankton microorganisms such as Isochrisis galbana and Chlorella sp.

This molecule shows a very good biocidal activity against most of the organisms taken into consideration which is often higher than that of quinones having an OH group in position 5 without otherwise sharing their high aggressiveness toward fish.

In summary, the above results show that MNB is a more effective biocidal agent than the reference compounds. Indeed, any skilled person know that members of the same class (e.g. Chlorella sp. and Isochris galbana, which belong to the class of micro-algae) will present substantially identical sensitivity to biocidal agents. Therefore, it is believed that even though in the above table MNB and the reference compounds are not tested against the same member of a given class, the above results clearly show that MNB can be significantly more effective than the reference compounds.

Furthermore, the above results show that MNB maintains its high effectiveness against all tested infesting organisms despite the highly varying nature of said organisms, and shows such high effectiveness even with respect to organisms against which the reference compounds fail to show any biocidal activity. Therefore, it is believed that the above results clearly indicate that MNB is a more versatile biocidal agent than the reference compounds.

### EXAMPLE 2

The second major aspect to be taken into consideration together with biocidal activity is the degradability of the various molecules.

From the hydrolysis test carried out in the dark, MNB and MPB appear to be readily degradable at a pH compatible with environmental conditions.

TABLE 2A

| ½ LIFE | Juglone | Menadione | MNB | MPB |
|---|---|---|---|---|
| pH 9 | 15 h | 550 h | <3 h | <3 h |
| pH 6, 8 | >288 h | 1500 h | 48 h | 48 h |

Similarly, the same behaviour is confirmed when evaluating the photo-degradability under daylight and UV (the irradiation test is carried out on a solution of 10 ppm in drinking water (pH 6,5-7,5)).

TABLE 2B

| Light exp. | Juglone | Menadione | MNB | MPB |
|---|---|---|---|---|
| ½ life | N.D. | 1500 h | 10 h | 10 h |
| Tot Degr. | 48 h | >5000 h | 48 h | 48 h |

Finally biodegradability was also evaluated according to standard 92/69/EEC C4-A. From the data, both MNB and MPB result to have a remarkably better biodegradability than 2-methyl-1,4-naphthalenedione and particularly than MSB.

TABLE 3

| % biodegr. | | | | | |
|---|---|---|---|---|---|
| OECD 301 A | Juglone | Menadione | MNB | MPB | MSB |
| after 7 days | N.A. | 0 | 37 | 37 | 5 |
| after 14 days | N.A. | 0 | 37 | 37 | 10 |
| after 28 days | N.A. | 0 | 40 | 40 | 17 |

Therefore, from this point of view, MNB and MPB are obviously advantageous over the use of any compound chemically related thereto, in that a better biodegradability OECD 301 (and generally a better degradability in the light and as a function of pH) lead to expect they have a remarkably shorter average life when unloaded in sea water together with ballast water and therefore a less risky nature for the ichthyic fauna.

### EXAMPLE 3

As reminded often, the water solubility is an essential feature for the candidate biocide to be used successfully in the biological control of water. Therefore, it has been proceeded with evaluating this property for four compounds of the chemical classes to which the biocides currently being used belong. (Water solubility of juglone has been assessed without using adjuvant organic solvents such as alcohols or acetone.)

TABLE 4

| Sol. in H₂O | | | | |
|---|---|---|---|---|
| (gr/l at 20° C.) | Juglone | Menadione | MNB | MPB |
| | Ins. | ins. | 19 | 10 |

From the data of the above table, the difficulties are clearly obvious which would arise in case one decided to exploit the biocidal properties of molecules such as juglone and menadione without resorting, either by choice or by impossibility, to premixing said compounds in suitable solvents before adding them in the mass of water to be treated.

Indeed, with dosages compatible with any possible use according to the present invention and particularly if ballast waters are considered (in which case the dosage would be of a few ppm) it is difficult to ensure an even distribution of the active principle in the water; a particle of the active principle for example can be effective in the immediate surroundings of said particle but innocuous for the great bulk of water.

Also the particle density can play an important role in this regard: particularly, if the particle is denser than water, it will settle on the bottom; whereas if it is less dense, it will float on the surface. In any event an even distribution seems to be impossible.

### EXAMPLE 4

MNB compound was tested particularly for its biocidal activity on pathogenic and non pathogenic bacteria.

The biocidal activity of MNB was assessed using two distinct methods: the disk diffusion test on agar plates (Kirby-Bauer Method) and the broth dilution method to assess the Minimum Inhibitory Concentration (MIC) and the Minimum Bactericidal Concentration (MBC).

a) Kirby-Bauer assay was carried out after 24 hours in the dark.

In the disk diffusion susceptibility test, paper disks containing known amounts of MNB are placed on the surface of an agar plate that has been inoculated confluently with a standardized suspension of an indicator bacterial strain. The antimicrobial agent diffuses into the medium causing a zone of inhibition of growth of the strain around the disk corresponding to the susceptibility of the strain to that agent. Interpretative zone diameters have been established to permit classifying an isolate as belonging to the susceptible, intermediate resistance, or resistant categories of susceptibilities to an antimicrobial agent.

The disk diffusion method on agar plates was used to assess the biocide efficacy of a single concentration of MNB (100 mg) against four aerobic quality control strains (Pseudomonas aeruginosa ATCC10145, Pseudomonas elongata NCIMB 1141, Bacillus subtilis ATCC 10774 and Staphylococcus aureus ATCC 25923).

Test results are summarised in Table 5 and represent the size of the inhibition halos in millimetres after contact with 100 μg MNB (Disk diffusion method).

Table 5: Antimicrobial activities of MNB assayed against Gram positive (Bacillus subtilis, Staphylococcus aureus) and Gram negative bacteria (Pseudomonas elongata, Pseudomonas aeruginosa)(diameters of

TABLE 5

| | |
|---|---|
| Indicator lawns | 100 μg |
| Pseudomonas aeruginosa ATCC | 0 mm |
| 10145 | |
| Bacillus subtilis ATCC 10774 | 0 mm |
| Pseudomonas elongata NCIMB 1141 | 20 mm |
| Staphylococcus aureus ATCC 25923 | 20 mm |

b) Serial dilution test: the antibiotic activity is determined quantitatively by using the known sensitivity of a test strain towards an antibiotic which is expressed numerically as the minimal inhibitory concentration (MIC) and the minimal bactericidal concentration (MBC).

Procedure: serial dilutions of the antibiotic to be tested are pipetted into the antibiotic broth, this is then inoculated with a defined quantity of the relevant test strain (FIG. 4).

The Minimum Inhibitory Concentration (MIC) was defined as the lowest concentration of antibiotic which prevented visual turbidity after incubation. Evaluation: The last tube which does not show any turbidity due to microbial growth contains the active antibiotic at a concentration corresponding to the MIC.

The Minimum Bactericidal Concentration (MBC) is defined as the lowest concentration of an antibiotic killing the majority of a bacterial inoculum (99.9%, equivalent to a thousand-fold reduction of the inoculum). Method: Following a broth dilution MIC test, from each tube in the dilution series a defined volume (20 μL) is spread onto plates without antibiotics. To minimize the carry-over effect of antibiotic from the test tubes, let the drop “dry” before the inoculum is spread over the surface (a section of the agar plate). The plates were incubate overnight (longer for slow growing bacteria) and then counted the number of colonies growing from each of the test tubes. The number of colonies corresponding to a thousand-fold reduction (MBC) can be calculated if the colony count of the start inoculum is known.

The microdilution broth method was used to evaluate the MIC and the MBC against 15 aerobic bacteria isolated from culture collection and seawater. Antimicrobial dilutions were performed using Mueller Hinton Broth supplemented with divalent cations. The tested product was dissolved in the medium to obtain a final range concentration between 0,12 to 64 mg/l.

Antimicrobial assays were performed in dark, and results were read after 24 h of incubation at 25° C. Each test towards the same indicator strain was performed in three replicates.

The assayed strains were environment isolates identified by an internal number or standard strains identified by the ATCC or NCIMB accession number. The results obtained are summarised in Table 6.

Table 6: Values of MIC and MBC for the compound MNB, against culture collection strains and marine bacteria.

TABLE 6

| | MIC (mg/l) | MBC (mg/l) |
|---|---|---|
| Gram positive strains | | |
| Bacillus subtilis ATCC 10774 | 12 | 32 |
| Bacillus licheniformis NCIMB 1525 | 16 | 32 |
| Staphylococcu aureus ATCC 25923 | 8 | 16 |
| Micrococcus sp. AE11 | 8 | 16 |
| Micrococcus sp. AD10 | 16 | 32 |
| Corynebacterium sp. CT15 | 8 | 16 |
| Gram negative strains | | |
| Pseudomonas aeruginosa ATCC 10145 | >64 | >64 |
| Pseudomonas elongata NCIMB 1141 | 8 | 16 |
| Pseudomonas putida NCIMB 1960 | >64 | >64 |
| Escherichia coli ATCC 25922 | >64 | >64 |
| Aeromonas sp. CH34 | 32 | 64 |
| Vibrio parahaemolyticus AD19 | 1 | 4 |
| Vibrio sp. AD18 | 16 | 32 |
| Vibrio sp. CH45 | 16 | 16 |
| Vibrio sp. AE7 | 32 | 64 |

The disclosures in Italian Patent Application No. MI2003A001011 from which this application claims priority are incorporated herein by reference.

What is claimed is:

1. A method for preventing growth or eliminating the presence of at least one aquatic infesting microorganism, wherein said method comprises the step of adding at least one compound selected from the group consisting of: menadione nicotinamide bisulphite (MNB), menadione dimethylpyrimidinole bisulphite (MPB), menadione nicotinic acid bisulphite, menadione adenine bisulphite, menadione triptophane bisulphite, menadione histidine bisulphite, menadione para-aminobenzoic acid bisulphite to the water which is at risk of being contaminated or already infested by said aquatic infesting organism,
and wherein said at least one aquatic infesting organism is selected from the group consisting of phytoplankton organisms, dinoflagellates, diatoms, zooplankton organisms and bacteria.

2. The method according to claim 1, wherein the organisms to be treated are non-indigenous species including aquatic and marine plants, phytoplankton and zooplankton organisms, propagules and gram positive and gram negative bacteria.

3. The method according to claim 2, wherein the zooplankton organisms are adults, larval stages and resting stages.

4. The method according to claim 2, wherein the bacteria and phytoplankton organisms are vital or resting stages.

5. The method according to claim 1, wherein said water pool to be treated is water used as ballast waters in the maritime practice.

6. The method according to claim 1, wherein said water pool to be treated is fresh or salt water from basins of any size.

7. The method according to claim 1, wherein said water pool to be treated is water from civil and industrial conduits.

8. The method according to claim 1, wherein said water pool to be treated is fresh or salt water of aquaria of any shape and size.

9. The method according to claim 1, wherein said phytoplankton organisms are green-algae.

10. The method according to claim 1, wherein said zooplankton organisms are selected from the group consisting of larval stages of copepods, crustaceans and molluscs.

11. The method according to claim 9, wherein said phytoplankton organism is Isochrisis galbana.

12. The method according to claim 10, wherein zooplankton organisms are selected from the group consisting of Dreissena polymorpha, Eurytemora affinis and Artemia salina.

13. The method according to claim 1, wherein said bacteria are selected from the group consisting of bacteria of the Enterobacteriaceae, Pseudomonaceae, Alteromonadaceae, Vibrionaceae, Micrococcaceae and Bacillaceae families.

14. The method according to claim 13, wherein said bacteria are selected from the group consisting of bacteria of the Escherichia, Salmonella, Pseudomonas, Alteromonas, Bacillus, Corynebacterium, Vibrio, Aeromonas, Micrococcus, Staphylococcus and Clostridium genera.

15. The method according to claim 14, wherein said bacteria are selected from the group consisting of Escherichia coli, Shigella sonnei, Staphylococcus aureus, Vibrio parahaemolyticus, Bacillus subtilis and Proteus.

16. The method according to claim 1, wherein the compound added to the water to be treated is menadione nicotinamide bisulphite (MNB).

17. The method according to claim 1, wherein the compound to be added to the water pool is used in an amount of 0.5 ppm to 500 ppm.

18. The method according to claim 1, wherein said quantity is of 0.5 ppm to 200 ppm.

19. The method according to claim 18, wherein the quantity is of 1 ppm to 100 ppm.
